(19) United States
(12) Patent Application Publication
(10) Pub. No.: US 2008/0102343 A1
(43) Pub. Date: May 1, 2008

(54) Mounting structure of fuel cell stack

(76) Inventors: Sang Hyun Cho, Seoul (KR); Young Bum Kum, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/646,115

(22) Filed: Dec. 26, 2006

(30) Foreign Application Priority Data
Oct. 27, 2006 (KR) 10-2006-0105263

(51) Int. Cl. H01M 8/02

(52) U.S. Cl. 429/34

(57) ABSTRACT

A mounting structure of a fuel cell stack includes a first and a second end plate respectively attached to a first and a second side of a separation plate of the fuel cell stack, and a pair of enclosure panels detachably mounted to the end plates. The enclosure panels may be detachably mounted to the end plates by a recessed groove unit on each of the end plates, and a projection unit on each of the enclosure panels, detachably inserted in the recessed groove unit. Alternatively, the enclosure panels may be detachably mounted to the end plates by a recessed groove unit on each of the enclosure panels, and a projection unit on each of the end plates, detachably inserted in the recessed groove unit. A spring may further be provided for providing pressure between the separation plate and the end plates of one side.

### CROSS-REFERENCE TO RELATED APPLICATION

This application claims priority to and benefit of Korean Patent application NO. 10-2006-0105263, filed on Oct. 27, 2006, in the Korean Intellectual Property Office, the disclosure of which is incorporated herein by reference.

### BACKGROUND OF THE INVENTION

1. Field of the Invention

The present invention relates to a mounting structure of a fuel cell stack, and in particular, to a mounting structure of a fuel cell stack using a simple detachable structure.

2. Description of the Related Art

Recently, hydrogen fuel cells have been studied intensively and comprehensively. A unit cell is composed of a porous electrode, and an electrolyte located between an anode and a cathode. Power is generated when gaseous fuel is provided to the cathode and gas containing oxygen is provided to the anode, and electrons generated due to an electro-chemical reaction flows via an external circuit. Much electricity can be generated by stacking many cells into a stack.

Japanese Publication Patent 2006-66256 discloses a fuel cell stack mounting structure comprising an end plate at each end of a stacking body, a plurality of lateral plates on the lateral side of the stacking body, and a connection pin for connecting the end plates to the lateral plates. At least one of the lateral sides is formed by a panel including a rib, and the center of the connection pin is disposed on a middle surface of the panel that includes the rib to provide hardness and surface pressure.

Further, Japanese Publication 2006-140007 discloses a plurality of stacks, and a pair of end plates arranged along the plurality of stacks. A support member is provided between adjacent stacks. An insulation plate and a frame are further provided.

In both above-mentioned mounting structures, since many connection members, including bolts, must be used at the connection portions, the numbers of parts and processes are high.

The above information disclosed in this Background section is only for enhancement of understanding of the background of the invention and therefore it may contain information that does not form the prior art that is already known in this country to a person of ordinary skill in the art

### SUMMARY OF THE INVENTION

Embodiments of the present invention provide a mounting structure of a fuel cell stack in which a recessed groove unit is provided at the lateral side of upper and lower side end plates, and a projection unit is provided on the upper and lower frames of a left and right enclosure panel covering a fuel cell, and thus a left and right enclosure panel is connected to the end plates. A spring is provided between the fuel cell and the end plates, and thus a change of a surface pressure due to process deviation and thermal transformation can be compensated for, the number of processes is reduced due to the simplicity of the structure, the weight and the volumes are reduced, and the output density of a fuel cell is improved.

An exemplary embodiment provides a mounting structure of a fuel cell stack, including an end plate attached between an upper side and a lower side of a separation plate, and a pair of enclosure panels, each with a planar shape, one end of each of which is opened and the other end of which is closed, connected by a detachable mounting structure.

An exemplary embodiment includes a recessed groove unit with a concave shape along a periphery of the lateral side of the end plates, and a projection unit with a convex shape on an upper and a lower frame of the enclosure plate on which the recessed groove unit is formed. The recessed groove unit and projection unit are inserted mutually, and attached.

Alternatively, the projection unit is provided along the periphery of the lateral side of the end plates, and the recessed groove unit is provided on the upper and lower frames of the enclosure plate.

Further, a spring which provides a constant surface pressure and functions as a buffer is provided between the separation plate and the end plates of one side.

### BRIEF DESCRIPTION OF THE DRAWINGS

These and other aspects and advantages of the invention will become apparent and more readily appreciated from the following description of the preferred embodiments, taken in conjunction with the accompanying drawings, in which:

FIG. 1 is a diagram showing a mounting structure of a fuel cell stack according to an embodiment of the present invention.

FIG. 2 is a cross-section taken along line A-A of FIG. 1.

FIG. 3 illustrates a projection unit of an enclosure panel according to an embodiment of the present invention.

FIG. 4 illustrates a recessed groove unit of an end plate according to an embodiment of the present invention.

### DETAILED DESCRIPTION OF THE PREFERRED EMBODIMENTS

Exemplary embodiments of the present invention will be explained in detail with referring to the attached drawings.

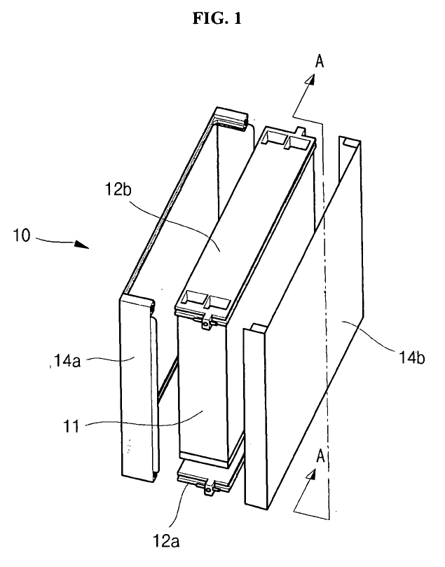

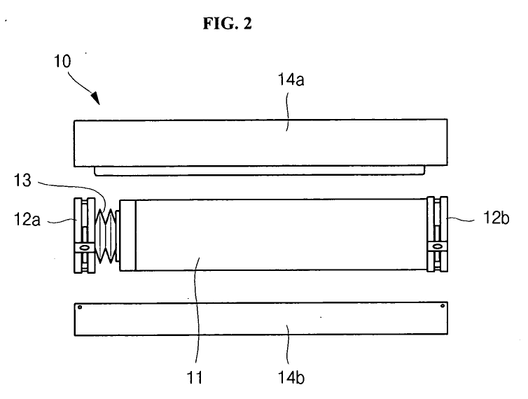

As shown in FIG. 1 and FIG. 2, in a fuel cell stack, a plurality of separation plates II are attached by stacking with MEA(Membrane Electrolyte Assembly), and a gas diffusion layer between them, and end plates 12a, 12b are attached to the upper and lower sides of the separation plates 11.

One terminal(plus or minus terminal) is formed on the end plates 12a, 12b.

The enclosure panel 14a, 14b has a bent, thin planar shape, one side of which is open, and the other side which is closed. The exterior area of the separation plates 11 and the end plates 12a, 12b may be identical to the interior area of the enclosure panel 14a, 14b.

When the separation plates 11 and the end plates 12a, 12b are attached, the enclosure panels 14a, 14b are attached at the left and right sides, respectively.

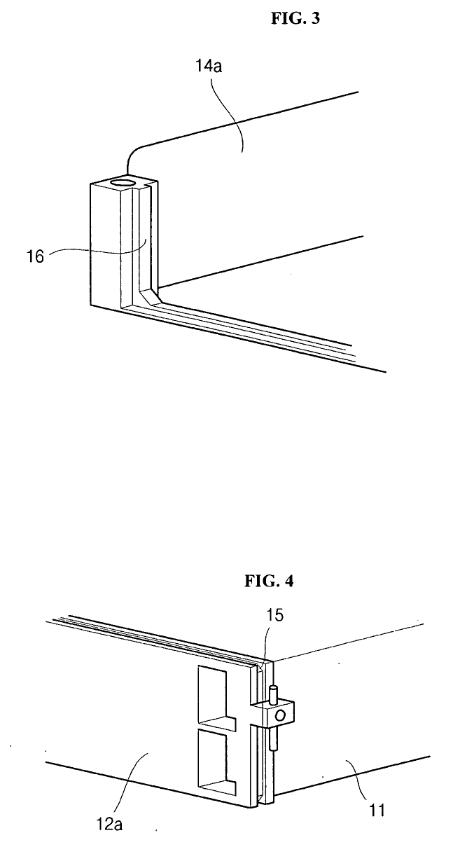

A detachable mounting structure is attained by the recessed groove unit 15 of the end plates 12a, 12b of FIG. 4 and the projection unit 16 of the enclosure panel 14a, 14, as seen in FIG. 3.

The recessed groove unit 15 is concave along a periphery of the lateral side of the end plates 12a, 12b, and the projection unit 16 is convex on an upper frame and a lower frame of the enclosure plate 14a, 14b on which the recessed groove unit 15 is formed, thereby the projection unit 16 is inserted into and attached to the recessed groove unit 15.

Alternatively, the projection unit 16 may be provided along a periphery of the lateral side of the end plates 12a, 12b, and the recessed groove unit 15 may be provided on an upper frame and a lower frame of the enclosure plate 14a, 14b.

A spring 13 which provides a constant surface pressure and functions as a buffer is provided between the separation plate 11 and the end plates 12a, 12b. Because of such a feature, even though errors are generated due to process deviation and thermal transformations of the fuel cell stack 10, stable mounting is achieved.

Below, mounting of a fuel cell stack according to an embodiment of the present invention will be explained as follows.

First, spring 13 is provided between the separation plates 11 and the end plates 12a, 12b of one side.

At this time, the recessed groove unit 15 is exposed on the lateral side of the end plates 12a, 12b, then the separation plates 11 of the left side and the right side are attached on both sides of the fuel cell stack 10. The projection unit 16 on the upper frame and the lower frame of the enclosure panels 14a, 14b is inserted into the recessed groove unit 15.

As explained above, in the mounting structure of a fuel cell stack according to the present invention, there are following merits.

1. Since hardness is secured in a fuel cell stack itself, and thus the size of the external enclosure can be reduced, the output density of the fuel cell per a volume is improved.

2. Since a spring is provided inside the mounting structure, even when the temperature of the fuel cell stack changes, a stable surface pressure can be maintained and thereby stability is secured.

3. Since the number of parts required for mounting a fuel cell stack or re-assembling is reduced, the difference of mounting force due to a bolt mounting method is reduced, work efficiency is maximized, and the processes are simplified.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mounting structure of a fuel cell stack, comprising:
a first and a second end plate respectively attached to a first and a second side of a separation plate of the fuel cell stack; and
a pair of enclosure panels detachably mounted to the end plates.

2. The mounting structure of a fuel cell stack set forth in the claim 1, wherein the enclosure panels are detachably mounted to the end plates by:
a recessed groove unit on each of the end plates; and
a projection unit on each of the enclosure panels, detachably inserted in the recessed groove unit.

3. The mounting structure of a fuel cell stack set forth in the claim 1, wherein the enclosure panels are detachably mounted to the end plates by:
a recessed groove unit on each of the enclosure panels; and
a projection unit on each of the end plates, detachably inserted in the recessed groove unit. 4. The mounting structure of a fuel cell stack set forth in the claim 1, further comprising a spring for providing pressure between the separation plate and the end plates of one side.
